(19) United States
(12) Patent Application Publication
(10) Pub. No.: US 2026/0010175 A1
(43) Pub. Date: Jan. 8, 2026

(54) NAVIGATION SUPPORT DEVICE, AUTOMATIC BERTHING SYSTEM, NAVIGATION SUPPORT METHOD, NAVIGATION SUPPORT PROGRAM

(71) Applicant: Furuno Electric Co., Ltd., Nishinomiya (JP)

(72) Inventor: Shigeki OSAKI, Osaka (JP)

(21) Appl. No.: 19/324,021

(22) Filed: Sep. 9, 2025

Related U.S. Application Data
(63) Continuation of application No. PCT/JP2024/005064, filed on Feb. 14, 2024.

(30) Foreign Application Priority Data
Apr. 10, 2023 (JP) 2023-063383

(51) Int. Cl. G05D 1/661; G05D 1/644; G05D 107/00; G05D 107/80; G05D 109/30

(52) U.S. Cl. CPC G05D 1/661; G05D 1/644; G05D 2107/25; G05D 2107/84; G05D 2109/34

(57) ABSTRACT

The navigation support device includes processing circuitry. The processing circuitry generates a set of candidate values for a plurality of parameters associated with an automatic berthing control of a ship, performs simulations of a berthing behavior of the ship based on each set of candidate values for the plurality of parameters, performs evaluations of the berthing behavior for each set of candidate values for the plurality of parameters based on results of the simulations, and determines a control parameter associated with the automatic berthing control from the set of candidate values for the plurality of parameters, based on the results of the evaluation of the berthing behavior.

### CROSS-REFERENCE TO RELATED APPLICATION(S)

This application is a continuation application of PCT International Application No. PCT/JP2024/005064 which was filed on Feb. 14, 2024, and which claims priority to Japanese Patent Application No. JP2023-063383 filed on Apr. 10, 2023, the entire disclosures of each of which are herein incorporated by reference for all purposes.

### TECHNICAL FIELD

The present invention relates to a technology for generating berthing pier control parameters for automatically berthing a ship, and a technology for automatically berthing pier control using the generated berthing pier control parameters.

### BACKGROUND

Conventionally, there have been berthing pier support systems. The berthing pier support systems applicable to ships equipped with side thrusters.

However, the pier berthing support system cannot be applied to a ship having one propulsion force generating apparatus (or a plurality of synchronized propulsion force generating apparatuses) and one rudder (or a plurality of synchronized rudders). That is, depending on the specifications of the ship, the pier berthing support system cannot be used.

### SUMMARY

Therefore, an object of the present invention is to realize an automatic berthing control based on the specifications of the ship.

A navigation support device includes processing circuitry. The processing circuitry generates a set of candidate values for a plurality of parameters associated to the automatic berthing control of the ship, simulates berthing behavior of the ship based on each of the set of candidate values for the plurality of parameters, evaluates the berthing behavior for each of the set of candidate values for the plurality of parameters based on the results of the simulation, and determines a control parameter associated to the automatic berthing control, from the set of candidate values of the plurality of parameters based on the results of the evaluation of the berthing behavior.

In this configuration, it is evaluated if the berthing behavior of the automatic berthing control of the ship is suitable for each of the set of candidate values for the plurality of parameters. Then, the control parameter that may realize the berthing behavior with the highest evaluation is determined for the plurality of parameters associated to the automatic berthing control. By using the determined control parameter, the optimal control of the automatic berthing may be realized. Thus, the optimal automatic berthing may be realized based on the specifications of the ship.

In the navigation support device of the present invention, the processing circuitry performs simulation using a motion model of the ship determined based on ship information, including a shape of the ship. In this configuration, appropriate control parameters according to the shape of the ship maybe determined.

In the navigation support device of the present invention, the processing circuitry performs simulation based on shape of a pier that is a disturbance to the ship and a target of the automatic berthing control. In this configuration, suitable control parameters depending on the disturbance or the shape of the pier may be obtained from the simulation.

In the navigation support device of the present invention, the processing circuitry determines the control parameters based on the disturbance to the ship simulated by the simulation unit or the shape of the pier that is the object of the automatic berthing control. In this configuration, the appropriate control parameters according to the disturbance or the shape of the pier may be determined.

In the navigation support device of the present invention, the processing circuitry simulates position of the ship in the berthing behavior. The processing circuitry evaluates the position of the ship using the position of the ship. In this configuration, the evaluation is performed using the position of the ship as a concrete example, and the accuracy of the evaluation is improved by using the position of the ship.

In the navigation support device of the present invention, the processing circuitry simulates a heading direction of the ship in the berthing behavior. The processing circuitry evaluates a heading. In this configuration, as a specific example, the evaluation is performed using the heading of the ship, and the accuracy of the evaluation is improved by using the heading.

In the navigation support device of the present invention, the processing circuitry simulates the position and the heading of the ship in the berthing behavior. The processing circuitry evaluates the berthing behavior of the ship using the distance between the position of the ship and a target position of the automatic berthing control, an argument between a target direction of the ship toward the pier and the heading of the ship, and a two-dimensional speed of the ship. The target direction is also a target of the automatic berthing control. In this configuration, the berthing behavior of the ship is evaluated using the position and attitude of the ship to the target of the automatic berthing control, and the accuracy of the evaluation is further improved.

In the navigation support device of the present invention, the processing circuitry further evaluates, based on a vertical distance between the ship and the target position of the automatic berthing control. In this configuration, by further using the vertical distance between the ship and the target position of the automatic berthing control of the ship, the state of berthing on a wall opposite to a berthing pier wall including the target position is eliminated, and the accuracy of the evaluation is further improved.

The navigation support device of the present invention uses a black box optimization algorithm to determine the control parameters. In this configuration, highly accurate simulation results may be obtained.

In the navigation support device of the present invention, the control parameters include a throttle in an approach phase when the ship approaches the target pier for the automatic berthing control. In the navigation support device of the present invention, the control parameters include a start position of a berthing phase when the ship approaches the pier from the approach phase and transitions to the berthing phase. In the navigation support device of the present invention, the control parameters include a start position of a stopping transition phase when the ship approaches the pier from the berthing phase and transitions to the stopping transition phase. In the navigation support device of the present invention, the control parameters include a two-dimensional coordinate of a waypoint used in the approach phase. In the navigation support device of the present invention, the control parameter includes a two-dimensional coordinate of a temporary target position of the automatic berthing control. In these configurations, the control parameters important for the automatic berthing control are determined.

The automatic berthing pier system of the present invention, the processing circuitry acquires the control parameters determined by the navigation support device described in any of the foregoing. The processing circuitry acquires observation values including the position of the ship. The processing circuitry control a propulsion force and a rudder angle of the ship in the automatic berthing control, based on the observation value and the determined control parameters.

In this configuration, the automatic berthing pier is controlled using the control parameters suitable for the automatic berthing pier described above. Thus, the highly accurate automatic berthing control maybe realized.

In the automatic berthing system of the present invention, the observed values further include disturbances. The processing circuitry acquires the observation values, including a disturbance and selects a setting parameter corresponding to an observation value, from the control parameters determined. Based on the setting parameter, the processing circuitry controls the propulsion force and the rudder angle of the ship in the automatic berthing control.

In this configuration, disturbance is further taken into consideration, so that the automatic berthing with higher accuracy maybe realized.

In the automatic berthing system of the present invention, the processing circuitry calculates a predicted route at the time of the automatic berthing control, and a display unit for displaying the predicted route, are provided. In this configuration, a user (operator, etc.) may easily check the predicted route at the time of automatic berthing.

In the automatic berthing system according to the present invention, when the processing circuitry sets the position of the ship to the start position the automatic berthing control is initiated. In this configuration, a high-precision automatic berthing initiation associated with a timer is provided.

### BRIEF DESCRIPTION OF THE DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as claimed herein.

FIG. 1 is a flowchart showing an example of automatic berthing control according to an embodiment of the present invention;

FIG. 2 is a diagram showing an example of a transition of the berthing behavior of a ship in the automatic berthing control according to an embodiment of the present invention;

FIG. 3 is a diagram showing the main points in the approach phase of the automatic berthing control;

FIG. 4 is a diagram showing the main points in the berthing phase in the automatic berthing control;

FIG. 5 is a diagram showing the main points in the stop transition phase in the automatic berthing control;

FIG. 6 is a diagram showing the main points in the stopping phase of the automatic berthing control;

FIG. 7 is a table showing parameters previously determined by simulation for automatic berthing control;

FIG. 8 is a functional block diagram of a navigation support device according to an embodiment of the present invention; and

FIG. 9 is a functional block diagram showing an example of an automatic pier attachment system according to an embodiment of the present invention.

### DETAILED DESCRIPTION

Example apparatus are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

Navigation support technology and automatic pier berthing technology according to the embodiment of the present invention will be described with reference to the figures.

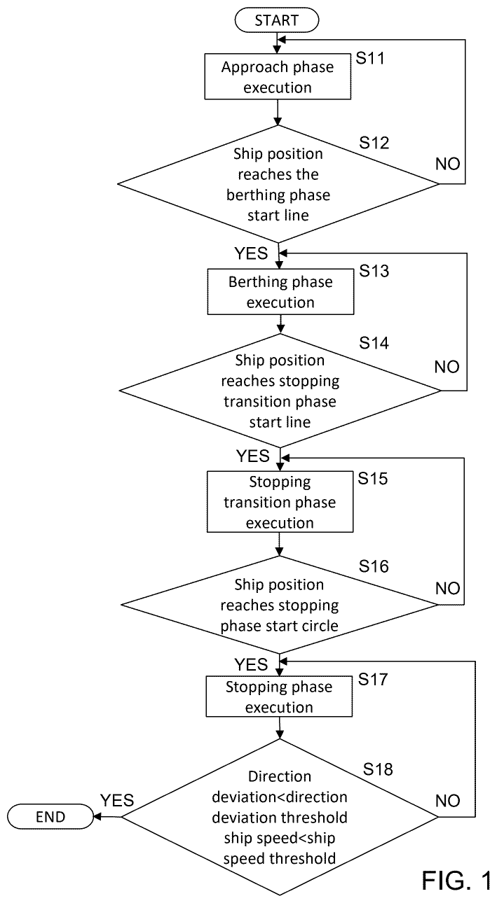

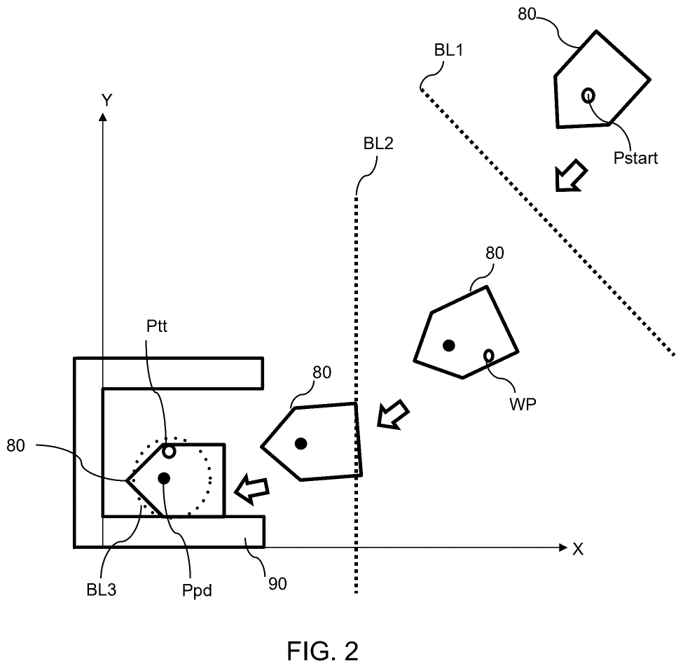

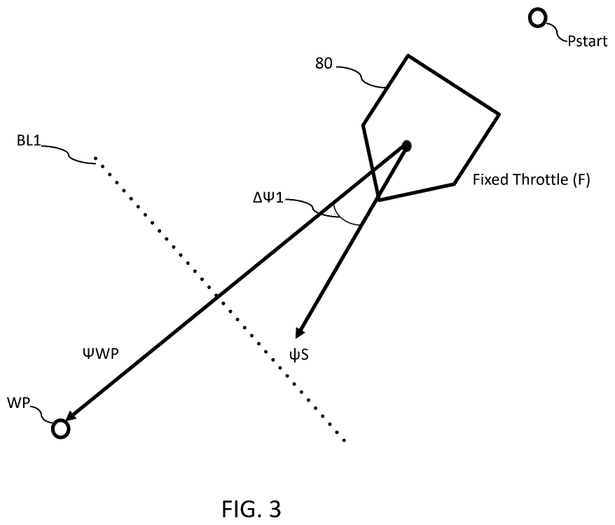

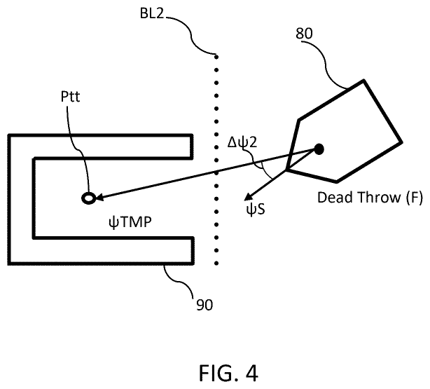

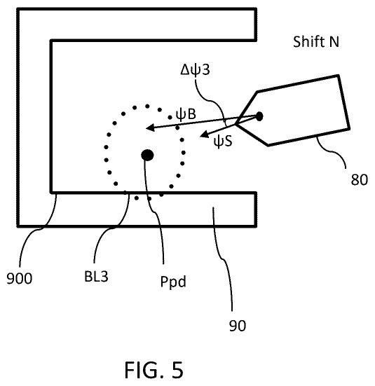

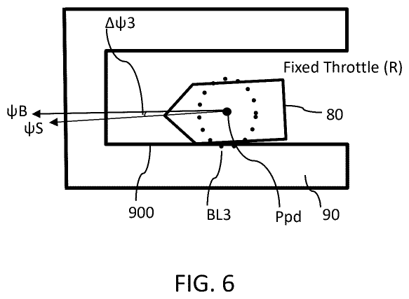

FIG. 1 is a flowchart showing an example of automatic berthing control according to an embodiment of the present invention. FIG. 2 is a diagram showing an example of transition of a ship's berthing behavior in the automatic berthing control according to an embodiment of the present invention. FIG. 3 is a diagram showing main points in an approach phase in the automatic berthing control. FIG. 4 is a diagram showing main points in a berthing phase in the automatic berthing control according to an embodiment of the present invention. FIG. 5 is a diagram showing main points in the stopping transition phase in the automatic berthing control according to an embodiment of the present invention. FIG. 6 is a diagram showing main points in the stopping phase in the automatic berthing control according to an embodiment of the present invention.

As shown in FIGS. 1 and 2 (Schematic flow of an automatic berthing control), the automatic berthing control comprises four control phases. Specifically, the automatic berthing control comprises control of an approach phase, control of a berthing phase, control of a stopping transition phase, and control of a stopping phase. In general, the automatic berthing control is executed in the order of control of the approach phase, control of the berthing phase, control of the stopping transition phase, and control of the stopping phase from a start of control to berthing.

Specifically, when the ship 80, subject to the automatic berthing control, reaches a start position Pstart of the control, the approach phase is executed (S11). The approach phase is executed (S11) until a position of the ship 80 reaches a berthing phase start line BL1 (S12: NO). The position of the ship 80 is a specific position (For example, the position where the positioning sensor is provided, the position of the wheelhouse) on the ship 80.

Further, the approach phase ends and the berthing phase is executed (S13), when the position of the ship 80 reaches the berthing phase start line BL1 (S12: YES). That is, the automatic berthing control shifts from the approach phase to the berthing phase. The berthing phase is executed (S13) until the position of the ship 80 reaches stopping transition phase start line BL2 of the berthing phase (S14: NO).

Furthermore, the berthing phase ends and the stopping transition phase is executed (S15), when the position of the ship 80 passes through the stopping transition phase start line BL2 (S14: YES). That is, the automatic berthing control shifts from the berthing phase to the stop transition phase. The stopping transition phase is executed (S15) until the position of the ship 80 reaches a stopping phase start circle BL3 (S16: NO).

The stopping transition phase ends and the stopping phase is executed (S17), when the position of the ship 80 passes the stopping phase start circle BL3 (S16: YES). That is, the automatic berthing control shifts from the stopping transition phase to the stopping phase. The stopping phase is executed until the direction deviation of the ship 80 becomes less than the direction deviation threshold and the ship speed becomes less than a ship speed threshold (S18: NO).

In one embodiment, the stopping phase ends and the automatic berthing control ends when the direction deviation of the ship 80 becomes less than the direction deviation threshold and the ship speed becomes less than the ship speed threshold (S18: YES).

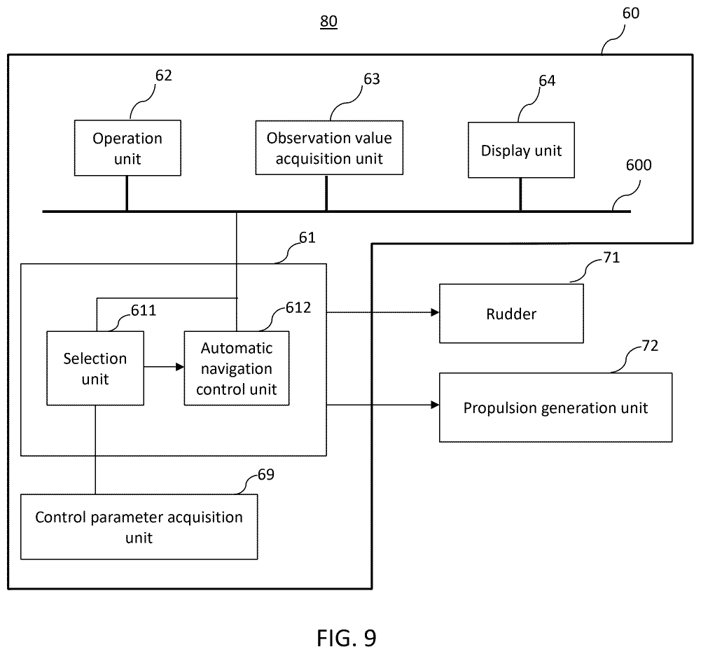

As shown in FIGS. 2 and 3, in the approach phase, an automatic navigation control unit 612 (see FIG. 9) of the ship 80 sets a forward fixed throttle (fixed throttle (F)) and controls a propulsion force by a propulsion generation unit 72 (see FIG. 9). This fixed throttle corresponds to an approach throttle.

In the approach phase, an waypoint WP is set as a navigation target of the ship 80. The waypoint WP is set in two-dimensional coordinates. The waypoint WP is set closer to a pier 90 than the berthing phase start line BL1.

The automatic navigation control unit 612 acquires a direction WWP of the waypoint WP relative to the position of the ship 80. The automatic navigation control unit 612 sets a command rudder angle so as to reduce a argument Δψ1 between the direction WWP of the waypoint WP and a heading ψS, and controls a rudder angle of a rudder 71 (see FIG. 9).

As shown in FIGS. 2 and 4, in the berthing phase, the automatic navigation control unit 612 sets a forward dead throw (dead throw (F)) and controls the propulsion force by the propulsion generation unit 72. The dead throw (F) sets a throttle opening to a minimum value for moving forward without setting the throttle opening to 0.

In the berthing phase, a temporary target position Ptt is set as the navigation target of the ship 80. The temporary target position Ptt is set in two-dimensional coordinates. The temporary target position Ptt is set, based on a target position Ppd and a disturbance. At this time, the temporary target position Ptt may refer to a shape of the pier 90.

The automatic navigation control unit 612 acquires a direction ψTMP of the temporary target position Ptt relative to the position of the ship 80. The automatic navigation control unit 612 sets the command rudder angle so as to reduce the argument Δψ2 between the direction ψTMP of the temporary target position Ptt and the heading ψS, and controls the rudder angle of the rudder 71.

As shown in FIGS. 2 and 5, in the stopping transition phase, the automatic navigation control unit 612 sets the shift to neutral (shift N) and stops the propulsion by the propulsion generating unit 72.

The automatic navigation control unit 612 acquires a direction ψB parallel to a berthing pier wall 900 of the pier 90 in the heading with respect to the position of the ship 80. The automatic navigation control unit 612 sets the command rudder angle so as to reduce the argument Δψ3 between the direction ψB and the heading ψS, and controls the rudder angle of the rudder 71.

(Stopping phase) As shown in FIGS. 2 and 6, in the stopping phase, the automatic navigation control unit 612 sets the forward fixed throttle (fixed throttle R) for the backward direction, and controls the propulsion force by the propulsion generation unit 72.

The automatic navigation control unit 612 acquires a direction ψB parallel to the berthing pier wall 900 of the pier 90 with respect to the position of the ship 80 in the heading. The automatic navigation control unit 612 sets the command rudder angle so as to reduce the argument Δψ3 between the direction ψB and the heading ψS, and controls the rudder angle of the rudder 71.

In such a control, in order to make the ship 80 arrive at the target position Ppd in a desired attitude with high accuracy, the following plural parameters for the automatic berthing control are important. The desired attitude at berthing is an attitude comprising the heading ψS and the direction ψB parallel to the berthing pier wall 900 (the argument Δψ3 becomes 0).

A plurality of parameters (control parameters) are fixed parameters and include parameters previously determined by simulation.

The fixed parameters include: the target position Ppd; stopping phase start circle BL3; throttle opening during dead throw; and throttle opening of the forward fixed throttle (fixed throttle (R)) at the back during the stopping phase.

The target position Ppd is expressed in two-dimensional coordinates (For example, as shown in FIG. 2, the X and Y coordinates relative to a specific position of the pier 90). The stopping phase start circle BL3 is represented by two-dimensional coordinates of a circle having a predetermined radius around the target position Ppd.

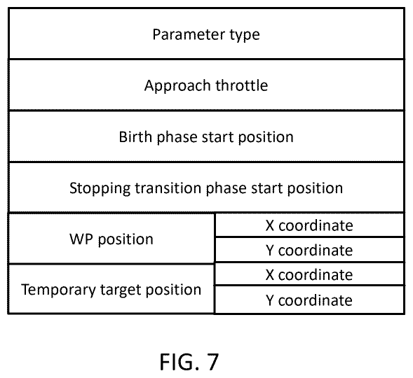

FIG. 7 is a table showing parameters previously determined by simulation for the automatic berthing control.

Specifically, parameters previously determined by simulation for the automatic berthing control include: an approach throttle, a berthing phase start position for determining the berthing phase start line BL1; a stopping phase start position for determining the stopping transition phase start line BL2; two-dimensional coordinates of the waypoint WP; and two-dimensional coordinates of the temporary target position Ptt.

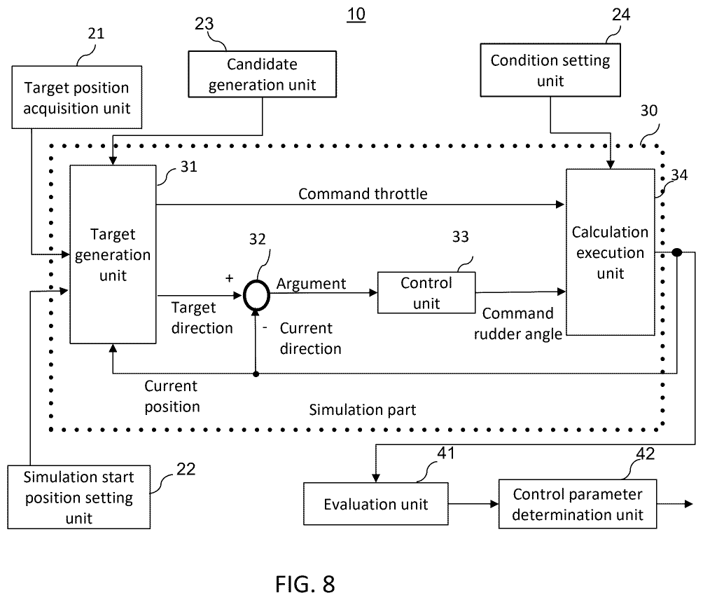

The parameters previously determined by the simulation are determined by the following navigation support devices. FIG. 8 is a functional block diagram of a navigation support device according to an embodiment of the present invention.

The navigation support device 10 is realized by an arithmetic processor that realizes the functional block shown in FIG. 8. The arithmetic processor includes, for example, a program for simulation, a storage medium for storing the program, and a CPU for executing the simulation.

The navigation support device 10 includes a target position acquisition unit 21, a simulation start position setting unit 22, a candidate generation unit 23, a condition setting unit 24, a simulation unit 30, an evaluation unit 41, and a control parameter determination unit 42.

The target position acquisition unit 21 acquires the target position Ppd. The target position Ppd is set by the specific position of the ship 80 when the ship 80 finally arrives at the pier 90, and is set by two-dimensional coordinates. The target position acquisition unit 21 outputs the target position Ppd to the simulation unit 30.

The simulation start position setting unit 22 sets the start position of the simulation, that is, the start position Pstart of the automatic berthing control. The start position Pstart is set in two-dimensional coordinates. A simulation start position setting unit 22 outputs a start position Pstart of the automatic berthing control to a simulation unit 30.

The candidate generation unit 23 sets a set of candidate values for a plurality of parameters determined by the simulation described above. The candidate generation unit 23 outputs the set of candidate values for the plurality of parameters to the simulation unit 30.

The condition setting unit 24 sets a simulation condition.

The simulation condition includes various kinds of hull information (Configuration of the rudder 71, configuration of the propulsion generating device, shape (total length, etc.) of the ship 80, draft height) and disturbances (Wind size, direction, etc.) that determine a motion model of the ship 80.

The configuration of the rudder 71 includes a number of rudders and whether or not the rudders are synchronized in the case of multiple rudders. The composition of propulsion force generating apparatus includes a number of propulsion force generating apparatuses, whether or not they are synchronized with each other in the case of a plurality of propulsion force generating apparatuses, and the like.

The condition setting unit 24 outputs various conditions to the simulation unit 30.

Although not shown, the fixed parameters described above are input or stored in the simulation unit 30.

The simulation unit 30 simulates the berthing behavior of the ship 80 based on the set of candidate values for the plurality of parameters. For example, the simulation unit 30 sets a first candidate value for the approach throttle, a first candidate value for the berthing phase start position, a first candidate value for the stopping transition phase start position, a first candidate value for the two-dimensional coordinate of the waypoint WP, and a first candidate value for the two-dimensional coordinate of the temporary target position Ptt as a first set of candidate values for the plurality of parameters. The simulation unit 30 simulates the berthing behavior of the ship 80 based on the candidate values of the first set of parameters. Similarly, the simulation unit 30 sets a second candidate value of the approach throttle, the second candidate value of the berthing phase start position, the second candidate value of the stopping transition phase start position, the second candidate value of the two-dimensional coordinates of the waypoint WP, and the second candidate value of the two-dimensional coordinates of the temporary target position Ptt as a second set of candidate values for the plurality of parameters. The simulation unit 30 simulates the berthing behavior of the ship 80 based on the candidate values of the second set of parameters. The simulation unit 30 further simulates each set of the candidate values of such parameters. Note that each set may have different parts of the candidate values.

For each set of candidate values for the plurality of parameters, the simulation unit 30 outputs, as a simulation result, the position (two-dimensional coordinates) and the heading of the ship 80 at multiple times. The simulation result may include the velocity (two-dimensional velocity) of the ship 80. If the velocity is not included, the velocity may be calculated from the position of the ship 80 at multiple times.

The simulation unit 30 includes a target generation unit 31, a argument calculation unit 32, a control unit 33, and a calculation execution unit 34.

The target generation unit 31 receives a set of the target position Ppd, the start position Pstart of the automatic berthing control, and the candidate values for the plurality of parameters. The target generation unit 31 receives the fixed parameters and the present position of the ship 80 in the simulation. The target generation unit 31 generates a command throttle and a target bearing according to a control phase based on an input information. The present position on the simulation is obtained as a result of the simulation by the calculation execution unit 34.

The target generation unit 31 determines the control phase based on the candidate value of the berthing phase start position BL1, the candidate value of the stopping transition phase start position BL2, the stopping phase start circle BL3, and the present position on the simulation.

In the approach phase, the target generation unit 31 generates the candidate value of the approach throttle (fixed throttle (F)) as the command throttle. The target generation unit 31 generates the direction ψWP of the waypoint WP based on the candidate values of the two-dimensional coordinates of the waypoint WP as a target direction.

In the berthing phase, the target generation unit 31 generates a dead throw as a command throttle. The target generation unit 31 generates an direction ψTMP of the temporary target position Ptt based on a candidate value of the two-dimensional coordinates of the temporary target position Ptt as the target direction.

In the stopping ship transition phase, the target generation unit 31 generates neutral (throttle 0) as the command throttle. The target generation unit 31 generates a direction ψB parallel to the berthing pier wall 900 of the pier 90 as the target direction.

In the stopping phase, the target generation unit 31 generates a fixed throttle R as the command throttle. The target generation unit 31 generates a direction ψB parallel to the berthing pier wall 900 of the pier 90 as the target direction.

The target generation unit 31 outputs the command throttle to the calculation execution unit 34. The target generation unit 31 outputs the target direction to the argument calculation unit 32.

The argument calculation unit 32 receives the target direction and a current direction (heading) on the simulation. The current direction on the simulation is obtained as a result of the simulation by the calculation execution unit 34. The argument calculation unit 32 calculates a difference value between the target direction and the current direction (heading), and outputs the difference value as the argument to the control unit 33.

The control unit 33 performs PID control by, for example, using the argument as an input and outputting the command rudder angle. At this time, the control unit 33 controls the command rudder angle so that the argument approaches 0. Each coefficient of the PID control may be set in advance based on a pilot test conducted in advance. Each coefficient of the PID control may be set according to each control phase, for example. The control unit 33 outputs the command rudder angle to the calculation execution unit 34.

The command throttle, the command rudder angle, and simulation conditions are input to the calculation execution unit 34.

The calculation execution unit 34 executes the simulation according to the above-mentioned algorithm using a hull motion model based on the simulation conditions with the command throttle and the command rudder angle as input.

As the simulation result, the calculation execution unit 34 generates the position and the heading of the ship 80 at multiple times. The calculation execution unit 34 feeds back the position (current position) of the ship 80 at multiple times to the target generation unit 31 and feeds back the heading (current direction) to the argument calculation unit 32. The calculation execution unit 34 outputs the position and the heading of the ship 80 at multiple times to the evaluation unit 41.

A simulation result for each set of the candidate values for the plurality of parameters is inputted to the evaluation unit 41. On the basis of the simulation result for each set of the candidate values of the plurality of parameters, the evaluation unit 41 evaluates the berthing behavior for each set of candidate values of the plurality of parameters. The berthing behavior is evaluated based on the process (Wake, time, etc.) of the ship's behavior from the start of the automatic berthing control to the berthing of the berthing target position. For example, the evaluation result shows as numerical values whether the berthing target position may be reached, how long it takes to reach the berthing target position, shape of a berthing track, shortness of the berthing track, etc.

Specifically, the evaluation unit 41 calculates the distance ΔL from the target position Ppd, the argument Δψ3 between the target direction (For example, the orientation ψB described above) and the heading ψS at the time of berthing, the resultant velocity U (the two-dimensional speed at the end of the stopping phase), and a vertical distance ΔY (the distance in the direction orthogonal to the berthing pier wall 900 including the target position (berthing position of the automatic berthing pier from the target position Ppd).

The evaluation unit 41 non-dimensionalizes the distance ΔL using an ideal berthing distance corresponding to the ship 80 from the berthing pier wall 900 of the pier 90. The evaluation unit 41 non-dimensionalizes a resultant velocity U using a ship speed threshold value in the stopping phase. The evaluation unit 41 non-dimensionalizes the vertical distance ΔY using the ideal berthing distance corresponding to the ship 80 from the berthing pier wall 900 of the pier 90. The evaluation unit 41 calculates an evaluation result (evaluation value) by multiplying the non-dimensionalized distance ΔL, the argument Δψ3, the non-dimensionalized resultant velocity U, and the non-dimensionalized vertical distance ΔY by a predetermined weighting factor and adding them. It should be noted that the calculation method of the evaluation result (evaluation value) is not limited to this, but is sufficient to realize the concept of the evaluation result described above.

The evaluation unit 41 outputs the evaluation result of each set of the candidate values for the plurality of parameters to the control parameter determination unit 42.

The control parameter determination unit 42 sets a plurality of candidate values constituting the set of candidate values of the plurality of parameters with the best evaluation result to the plurality of parameters used for the automatic berthing control described above. It should be noted that the best evaluation result indicates that the berthing may be performed most efficiently. For example, the one whose ship does not meander unnecessarily and whose berthing time is short corresponds to the most efficient berthing.

For example, when using the evaluation result (evaluation value) obtained by the above-mentioned calculation method, the control parameter determination unit 42 determines a plurality of parameters used for the automatic berthing control from the set of candidate values for the plurality of parameters, for which the evaluation result is minimum.

The process of determining the plurality of parameters by the candidate generation unit 23, the simulation unit 40, the evaluation unit 41, and the control parameter determination unit 42, as described above, is searched by, for example, a black box optimization algorithm. As the black box optimization algorithm, a Bayesian optimization algorithm, a genetic algorithm, and the like are adopted.
the control parameter determination unit 42 determines the plurality of parameters for each simulation condition. That is, the control parameter determination unit 42 determines a plurality of parameters for each combination of disturbance and ship specifications.

By performing such a simulation, the navigation support device 10 may generate a plurality of parameters suitable for automatic berthing control. Since the simulation is performed based on the disturbance and the specifications of the ship, the navigation support device 10 may optimally generate a plurality of parameters considering the disturbance and the specifications of the ship.

FIG. 9 is a functional block diagram showing an example of an automatic berthing system according to an embodiment of the present invention. The automatic berthing system includes an autopilot device 60, the rudder 71, and the propulsion generation unit 72.

The autopilot device 60 includes a control unit 61, an operation unit 62, an observation value acquisition unit 63, a display unit 64, and a control parameter acquisition unit 69. The autopilot device 60 is equipped on the hull of the ship 80 that performs autopilot control (automatic navigation control), for example.

The control unit 61 is connected to the rudder 71 and the propulsion generation unit 72. The rudder 71 and the propulsion generation unit 72 are mounted on the hull. The control unit 61 and the rudder 71 and the propulsion generation unit 72 are connected through, for example, an analog voltage or a data communication.

The control unit 61, the operation unit 62, the observation value acquisition unit 63, and the display unit 64 are connected to each other by, for example, a data communication network 600 for ships.

The operation unit 62 is realized by, for example, a touch panel, a physical button or a switch. The operation unit 62 accepts the setting related to the autopilot control and the automatic berthing control.

The observation value acquisition unit 63 is realized by various sensors, and acquires state data, indicating the state of the ship, such as the position of the ship, the heading, the ship speed, a response angular velocity, and the rudder angle. The observation value acquisition unit 63 acquires the observation value of the disturbances indicating the magnitude and direction of the wind, waves, and the like.

The display unit 64 is realized by, for example, a liquid crystal panel. The display unit 64 receives, for example, information related to autopilot control and automatic berthing control as input from the control unit 61. Although the display unit 64 may be omitted, it is preferable to provide the display unit 64. The presence of the display unit 64 enables the user to easily grasp the state of the autopilot control, the state of the automatic berthing control, and the like.

The control unit 61 includes a selection unit 611 and the automatic navigation control unit 612. The control parameter acquisition unit 69 is connected to the selection unit 611.

The control parameter acquisition unit 69 acquires a plurality of parameters for each combination of the disturbance generated as described above and the specifications of the ship. The control parameter acquisition unit 69 stores, for example, a plurality of sets of parameters for each combination of the disturbance and the specifications of the ship in a storage unit (not shown).

The selection unit 611 acquires the observed values of the disturbance from the observation value acquisition unit 63. The selection unit 611 selects a plurality of parameters (control parameters) corresponding to the acquired disturbance (observation value of the disturbance) as setting parameters. The selection unit 611 outputs the selected setting parameters to the automatic navigation control unit 612.

The automatic navigation control unit 612 acquires the position of the ship. The automatic navigation control unit 612 executes normal autopilot control (automatic navigation control referring to waypoints, etc.) when the position of the ship is not subject to the automatic berthing control. For example, when the position of the ship does not reach the start position Pstart of the automatic berthing control, normal autopilot control is executed.

When the position of the ship is the object of the automatic berthing control, the automatic navigation control unit 612 executes automatic berthing control based on the setting parameter given from the selection unit 611. For example, when the position of the ship reaches the start position Pstart of the automatic berthing control, the automatic berthing control is executed.

The automatic navigation control unit 612 outputs the command rudder angle generated by the autopilot control or the automatic berthing control to the rudder 71. Thus, the rudder angle of the rudder 71 is controlled. The automatic navigation control unit 612 outputs the command throttle generated by the autopilot control or the automatic berthing control to the propulsion generation unit 72. Thus, the propulsion of the propulsion generation unit 72, that is, the propulsion force of the ship 80, is controlled.

In the case of the automatic berthing control, the automatic navigation control unit 612 switches the control phase based on the position of the ship.

In general, the automatic navigation control unit 612 executes the approach phase when the ship 80 is located further from the berthing phase start line BL1 with respect to the pier 90. The automatic navigation control unit 612 executes the berthing phase when the ship 80 is located between the berthing phase start line BL1 and the stopping transition phase start line BL2.

The automatic navigation control unit 612 executes the stopping ship transition phase when the ship 80 is located on the pier 90 side of the stopping transition phase start line BL2 and outside the stopping phase start circle BL3. The automatic navigation control unit 612 executes the stopping ship phase when the ship speed is located inside the stopping phase start circle BL3 and the direction deviation (argument) is located above the ship speed threshold and the direction deviation threshold.

The automatic navigation control unit 612 terminates the stopping ship phase and terminates the automatic berthing control when the ship speed is located inside the stopping phase start circle BL3 and the direction deviation (argument) is located below the ship speed threshold and the direction deviation threshold.

Since such an automatic berthing system uses optimally set parameters as described above, the optimal automatic berthing control may be realized. In particular, the optimal automatic berthing control maybe realized even in the presence of external disturbances.

The technique of this embodiment may also be applied to a configuration in which one or more rudders are synchronized, or a configuration in which one or more propulsion generation units are synchronized. In such a configuration, it is generally difficult to perform the automatic berthing control, and the optimum automatic berthing control has been difficult in the past, but the optimum automatic berthing control may be realized by using the present technology.

In the automatic berthing system described above, the predicted route may be displayed. In this case, the control unit 61 includes a predicted route calculation unit. The predicted route calculation unit acquires its own ship position. The predicted route calculation unit calculates the predicted route at the time of automatic berthing based on its own ship position and a plurality of parameters. The predicted route calculation unit outputs the predicted route to the display unit 64. The display unit 64 displays the predicted route. Thus, the user may easily grasp the predicted route of the ship 80 in the self-propelled pier control.

Further, in the navigation support device 10 described above, the vertical distance ΔY from the target position Ppd need not be included in the evaluation value. However, by including the vertical distance ΔY in the evaluation value, the case of berthing on a wall opposite to the berthing wall 900 of the pier 90 may be excluded. Thus, a plurality of more suitable parameters may be generated.

In the above description, the pier 90 is formed of two parallel line segments and an orthogonal line segment, and a pier having a shape (U-shape) surrounded by these line segments is shown as an example, but the shape of the pier 90 is not limited to this.

### Terminology

It is to be understood that not necessarily all objectives or advantages may be achieved in accordance with any particular embodiment described herein. Thus, for example, those skilled in the art will appreciate that certain embodiments may be configured to operate in a manner that achieves or optimizes one advantage or group of advantages as taught herein without necessarily achieving other objects or advantages as may be taught or suggested herein.

All processes described herein may be embodied in, and fully automated via, software code modules executed by a computing system that includes one or more computers or processors. The software code modules may be stored in any type of non-transitory computer-readable medium or other computer storage device. Some or all methods may be embodied in specialized computer hardware.

Many other variations other than those described herein will be apparent from this disclosure. For example, depending on the embodiment, certain actions, events, or functions of any of the algorithms described herein may be performed in different sequences, and may be added, merged, or excluded altogether (e.g., not all described actions or events are required to execute the algorithm). Moreover, in certain embodiments, operations or events are performed in parallel, for example, through multithreading, interrupt handling, or through multiple processors or processor cores, or on other parallel architectures, rather than sequentially. In addition, different tasks or processes can be performed by different machines and/or computing systems that can work together.

The various exemplary logical blocks and modules described in connection with the embodiments disclosed herein can be implemented or executed by a machine such as a processor. The processor may be a microprocessor, but alternatively, the processor may be a controller, a microcontroller, or a state machine, or a combination thereof. The processor can include an electrical circuit configured to process computer executable instructions. In another embodiment, the processor includes an application specific integrated circuit (ASIC), a field programmable gate array (FPGA), or other programmable device that performs logical operations without processing computer executable instructions. The processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, the processor may also include primarily analog components. For example, some or all of the signal processing algorithms described herein may be implemented by analog circuitry or mixed analog and digital circuitry. A computing environment may include any type of computer system, including, but not limited to, a computer system that is based on a microprocessor, mainframe computer, a digital signal processor, a portable computing device, a device controller, or a computing engine within the device.

Unless otherwise stated, conditional languages such as “can,” “could,” “will,” “might,” or “may” are understood within the context as used in general to convey that certain embodiments include, while other embodiments do not include, certain features, elements and/or steps. Thus, such conditional languages are not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive languages, such as the phrase “at least one of X, Y, or Z,” unless specifically stated otherwise, is understood with the context as used in general to present that an item, term, etc., may be either X, Y, or Z, or any combination thereof (e.g., X, Y, and/or Z). Thus, such a disjunctive language is not generally intended to, and should not, imply that certain embodiments require at least one of X, at least one of Y, or at least one of Z to each be present.

Any process descriptions, elements, or blocks in the flow diagrams described herein and/or shown in the accompanying drawings should be understood as potentially representing modules, segments, or parts of code, including one or more executable instructions for implementing a particular logical function or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface”. The term “vertical” refers to a direction perpendicular to the horizontal as just defined. Terms such as “above,” “below,” “bottom,” “top,” “side,” “higher,” “lower,” “upper,” “over,” and “under” are defined with respect to the horizontal plane.

As used herein, the terms “attached,” “connected,” “coupled,” and other such relational terms should be construed, unless otherwise noted, to include removable, moveable, fixed, adjustable, and/or releasable connections or attachments. The connections/attachments can include direct connections and/or connections having intermediate structure between the two components discussed.

Numbers preceded by a term such as “approximately,” “about,” and “substantially” as used herein include the recited numbers, and also represent an amount close to the stated amount that still performs a desired function or achieves a desired result. For example, the terms “approximately,” “about,” and “substantially” may refer to an amount that is within less than 10% of the stated amount. Features of embodiments disclosed herein preceded by a term such as “approximately,” “about,” and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

1. A navigation support device, comprising:
processing circuitry configured to:
generate a set of candidate values for a plurality of parameters associated with an automatic berthing control of a ship;
perform simulations of a berthing behavior of the ship based on each set of candidate values for the plurality of parameters;
perform evaluations of the berthing behavior for each set of candidate values for the plurality of parameters based on results of the simulations; and
determine a control parameter associated with the automatic berthing control from the set of candidate values for the plurality of parameters, based on the results of the evaluation of the berthing behavior.

2. The navigation support device according to claim 1, wherein the processing circuitry is further configured to:
perform the simulations using a motion model of the ship determined based on ship information including a shape of the ship.

3. The navigation support device according to claim 1, wherein the processing circuitry is further configured to:
perform the simulations based on a disturbance to the ship or a shape of a pier that is a target of the automatic berthing control.

4. The navigation support device according to claim 1, wherein the processing circuitry is further configured to:
perform the simulations about a position of the ship in the berthing behavior, and perform the evaluations, based on the position of the ship.

5. The navigation support device according to claim 1, wherein the processing circuitry is further configured to:
perform the simulations about a heading of the ship in the berthing behavior, and perform the evaluations of the berthing behavior based on the heading.

6. The navigation support device according to claim 1, wherein the processing circuitry is further configured to:
perform the simulations about a position and a heading of the ship in the berthing behavior, and
perform the evaluations based on a distance between the position of the ship and a target position of the automatic berthing control, an argument between a target direction of the ship toward a pier, that is a target of the automatic berthing control, and the heading, and a two-dimensional speed of the ship.

7. The navigation support device according to claim 6, wherein the processing circuitry is further configured to:
perform the evaluation based on a vertical distance between the ship and the target position of the automatic berthing control.

8. The navigation support device according to claim 1, wherein the processing circuitry is further configured to:
execute the process of determining the control parameters by using a black box optimization algorithm.

9. The navigation support device according to claim 1,
wherein the control parameter includes a throttle in an approach phase when the ship approaches a pier, that is a target of the automatic berthing control.

10. The navigation support device according to claim 1,
wherein the control parameter includes a start position of a berthing phase when the ship approaches a pier from a approach phase and transitions to the berthing phase.

11. The navigation support device according to claim 1,
wherein the control parameter includes a start position of a stopping transition phase when the ship approaches a pier from a berthing phase and transitions to the stopping transition phase.

12. The navigation support device according to claim 1,
wherein the control parameter includes a two-dimensional coordinate of a waypoint used in an approach phase.

13. The navigation support device according to claim 1,
wherein the control parameter includes a two-dimensional coordinate of a temporary target position of the automatic berthing control.

14. An automatic berthing system comprising the navigation support device according to claim 1, wherein the processing circuitry is further configured to:
acquire the control parameters determined by the navigation support device;
acquire an observation value including a position of the ship; and
control a propulsion force and a rudder angle of the ship in the automatic berthing control, based on the observation value and the determined control parameters.

15. The automatic berthing system according to claim 14, wherein the processing circuitry is further configured to:
acquire the observation value, including a disturbance, and select a setting parameter, corresponding to the observation value, from the control parameters,
control the propulsion force and the rudder angle of the ship in the automatic berthing control based on the setting parameter.

16. The automatic berthing system according to claim 14, wherein the processing circuitry is further configured to:
calculate a prediction route at the time of the automatic berthing control of the ship; and
wherein the automatic berthing system further comprises a display configured to display the prediction route.

17. The automatic berthing system according to claim 14, wherein the processing circuitry is further configured to:
initiate the automatic berthing control when the position of the ship reaches a start position of the automatic berthing control.

18. The navigation support device according to claim 2, wherein the processing circuitry is further configured to:
perform the simulations based on a disturbance to the ship or a shape of a pier that is a target of the automatic berthing control.

19. A navigation support method, comprising:
generating a set of candidate values for a plurality of parameters associated with an automatic berthing control of a ship;
performing simulations of a berthing behavior of the ship based on each set of candidate values for the plurality of parameters;
performing evaluations of the berthing behavior for each set of candidate values for the plurality of parameters based on results of the simulations; and
determining a control parameter associated with the automatic berthing control from the set of candidate values for the plurality of parameters, based on the results of the evaluation of the berthing behavior.

20. A non-transitory computer-readable medium having stored thereon computer-executable instructions which, when executed by a computer, cause the computer to:
generate a set of candidate values for a plurality of parameters associated with an automatic berthing control of a ship;
perform simulations of a berthing behavior of the ship based on each set of candidate values for the plurality of parameters;
perform evaluations of the berthing behavior for each set of candidate values for the plurality of parameters based on results of the simulations; and
determine a control parameter associated with the automatic berthing control from the set of candidate values for the plurality of parameters based on the results of the evaluation of the berthing behavior.
